(19) United States
(12) Patent Application Publication
(10) Pub. No.: US 2011/0007146 A1
(43) Pub. Date: Jan. 13, 2011

(54) SUBSTRATE INSPECTION DEVICE AND SUBSTRATE INSPECTION METHOD

(75) Inventors: Kenichi Kaida, Osaka (JP); Noboru Higashi, Yamanashi (JP); Yoshiaki Awata, Yamanashi (JP); Kazuhide Nagao, Yamanashi (JP); Hideki Sumi, Yamanashi (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Kadoma-shi, Osaka (JP)

(21) Appl. No.: 12/922,359

(22) PCT Filed: Mar. 13, 2009
(86) PCT No.: PCT/JP2009/055546

§ 371 Date: Sep. 13, 2010

(30) Foreign Application Priority Data
Mar. 14, 2008 (JP) 2008-065376

(51) Int. Cl. H04N 7/18

(52) U.S. Cl. 348/87; 348/E07.085

(57) ABSTRACT

An inspection process before component mounting for all component mounting positions on which components are to be mounted is performed when a reenter mode is not set by operation of a reenter switch, a recognition camera is first caused to recognize the component mounting position and then a component presence inspection process which inspects whether or not the component is mounted on the component mounting position is performed when the reenter mode is set by the reenter switch, and, the inspection process before component mounting is performed for the component mounting position on which the component is not mounted.

### 1. TECHNICAL FIELD

The present invention relates to a substrate inspection device and a substrate inspection method for inspecting whether or not components can be mounted on component mounting positions on a substrate before the components are mounted.

### 2. BACKGROUND ART

A component mounter moves a mounting head relative to a positioned substrate, picks up components supplied from a component supplying unit, and mounts the components on a component mounting position on the substrate. A substrate inspection device is disposed at an upper stream side of a component mounter in a component mounting line (at an upper stream side of flow of a substrate) and the substrate inspection device recognizes component mounting positions on the substrate before components are mounted thereon by a recognition camera and inspects whether or not, the components can be mounted on the component mounting positions (inspection before component mounting) (Patent Documents 1 and 2).

Although the component mounter does not mount a component on a component mounting position (defective position) determined by the substrate inspection device that the component cannot be mounted thereon, since a mark indicating the defective position is put in the substrate, an operator can inspect the defective position of the substrate discharged from the component mounter visually and repair the defective position if repairable. In addition, when the operator again enters the substrate having the defective position repaired in the component mounting line and it is determined that a component can be again mounted on the component mounting position determined to be defective in the first inspection (inspection before component mounting in typical substrate entrance), since the component is mounted on the component mounting position, the substrate can be treated as a good article.

### Patent Document 1: Japanese Patent Laid-open Publication No. 2007-149817

### Patent Document 2: Japanese Patent Laid-open Publication No. 2005-5290

However, for all that many components have been already mounted on the substrate again entered in the mounting line, the substrate inspection device performs the inspection before component mounting for all component mounting positions on the substrate. This had a problem of low efficiency (further reduction of an overall throughput of the mounting line) since even component mounting positions to which the inspection before component mounting is naturally unnecessary and on which the components have been already mounted are inspected. In addition, when the components are mounted on the component mounting positions, since the component mounting positions may be concealed by the components mounted thereon in many cases, in the inspection before component mounting in reentrance of the substrate, when the component mounting positions are to be recognized in the same field of vision as the recognition camera, which is set for the first inspection, the component mounting positions within the field of vision can not be recognized, which may be determined to be abnormal and accordingly may result in occurrence of system errors.

### DISCLOSURE OF THE INVENTION

It is therefore an object of the present invention to provide a substrate inspection device and a substrate inspection method which are capable of efficiently performing an inspection before component mounting when a substrate is again entered, thereby preventing system errors from occurring.

According to a first aspect, there is provided a substrate inspection device including: a recognition camera that is movable with respect to a positioned substrate; an inspection execution unit that causes the recognition camera to recognize a component mounting position on the substrate and performs an inspection process before component mounting which inspects whether or not a component can be mounted on the component mounting position; and a reenter mode setting unit that sets the inspection execution unit to a reenter mode, wherein the inspection execution unit performs the inspection process before component mounting for all component mounting positions on which components are to be mounted when the reenter mode is not set by operation of the reenter mode setting unit, first causes the recognition camera to recognize the component mounting position and then performs a component presence inspection process which inspects whether or not the component is mounted on the component mounting position when the reenter mode is set by operation of the reenter mode setting unit, and, as a result, performs the inspection process before component mounting for the component mounting position on which the component is not mounted.

According to a second aspect, the substrate inspection device according to the first aspect is provide in a component mounter that moves a mounting head with respect to the positioned substrate and mounts the component on the component mounting position on the substrate, and the recognition camera is mounted on a camera head that is movably provided independent of the mounting head.

According to a third aspect, there is provided a substrate inspection method for causing a recognition camera, which is movably provided with respect to a positioned substrate, to recognize a component mounting position on the substrate, and performing an inspection process before component mounting which inspects whether or not a component can be mounted on the component mounting position, wherein the inspection process before component mounting for all component mounting positions on which components are to be mounted is performed when a reenter mode is not set by a reenter mode setting unit, the recognition camera is first caused to recognize the component mounting position and then a component presence inspection process which inspects whether or not the component is mounted on the component mounting position is performed when the reenter mode is set, and, as a result, the inspection process before component mounting is performed for the component mounting position on which the component is not mounted.

In the present invention, in normal substrate entrance where the reenter mode is not set, the inspection process before component mounting for all the component mounting positions on which components are to be mounted is performed, and, in substrate reentrance where the reenter mode is set, the recognition camera is first caused to recognize the component mounting position and then the component presence inspection process which inspects whether or not the component is mounted on the component mounting position is performed. As a result, the inspection before component mounting for the component mounting position on which the component is not mounted is performed. Accordingly, it is possible to efficiently perform the inspection before component mounting without performing an unnecessary inspection before component mounting for a component mounting position on which the component has been already mounted.

In addition, since the component presence inspection process in reentrance of the substrate is performed in a field of vision of the recognition camera suitable for inspection of the presence of the component (a field of vision on the assumption that the component is mounted on the component mounting position), if the component is not mounted on the component mounting position, the component mounting position is recognized (thereafter, when the field of vision is switched to a field of vision suitable for determining good/bad of the component mounting position, a good/bad determination on the component mounting position can be performed). On the other hand, if the component is mounted on the component mounting position, since the component is recognized, there is no abnormality to be determined and accordingly there occurs no system error.

### BRIEF DESCRIPTION OF THE DRAWINGS

FIG. 1 is a perspective view of a component mounter attached with substrate inspection device according to an embodiment of the present invention.

FIG. 2 is a plan view of the component mounter attached with substrate inspection device according to the embodiment of the present invention.

FIG. 3 is a block diagram showing a control system of the component mounter attached with substrate inspection device according to the embodiment of the present invention.

FIG. 4 is a plan view of an exemplary substrate on which components are mounted by the component mounter attached with substrate inspection device according to the embodiment of the present invention.

FIG. 5 is a flow chart showing a sequence of component mounting performed by the component mounter attached with substrate inspection device according to the embodiment of the present invention.

FIG. 6 is a flow chart showing a sequence of component mounting performed by the component mounter attached with substrate inspection device according to the embodiment of the present invention.

### BEST MODE FOR CARRYING OUT THE INVENTION

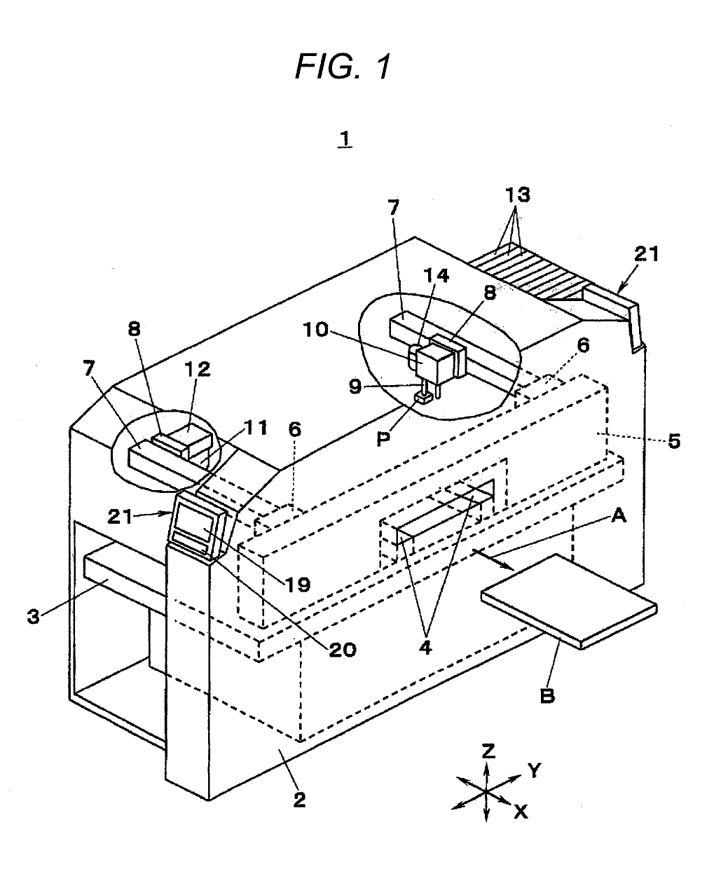

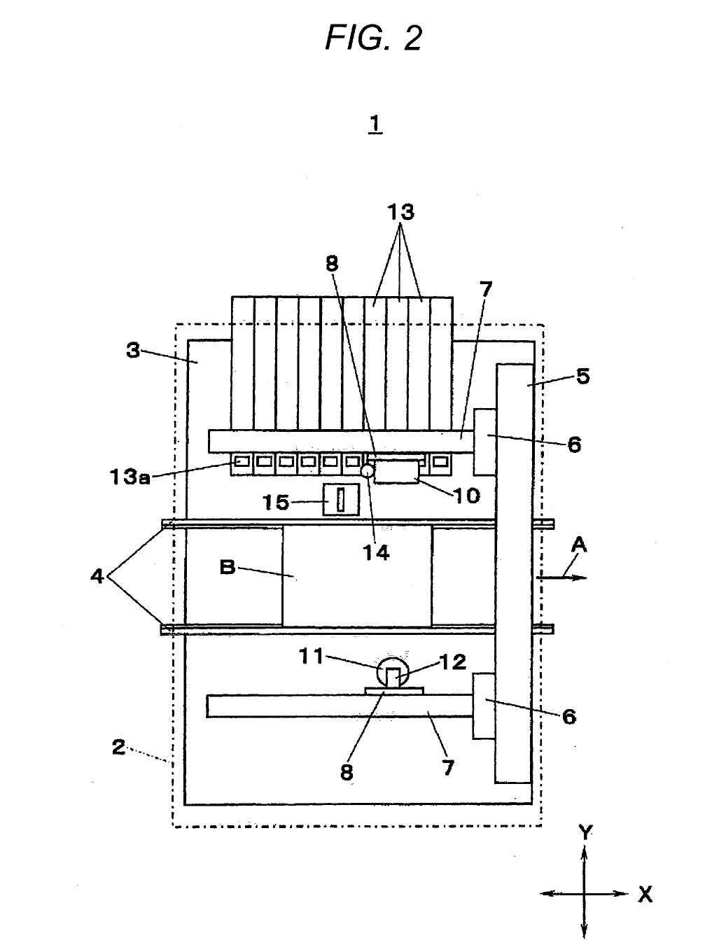

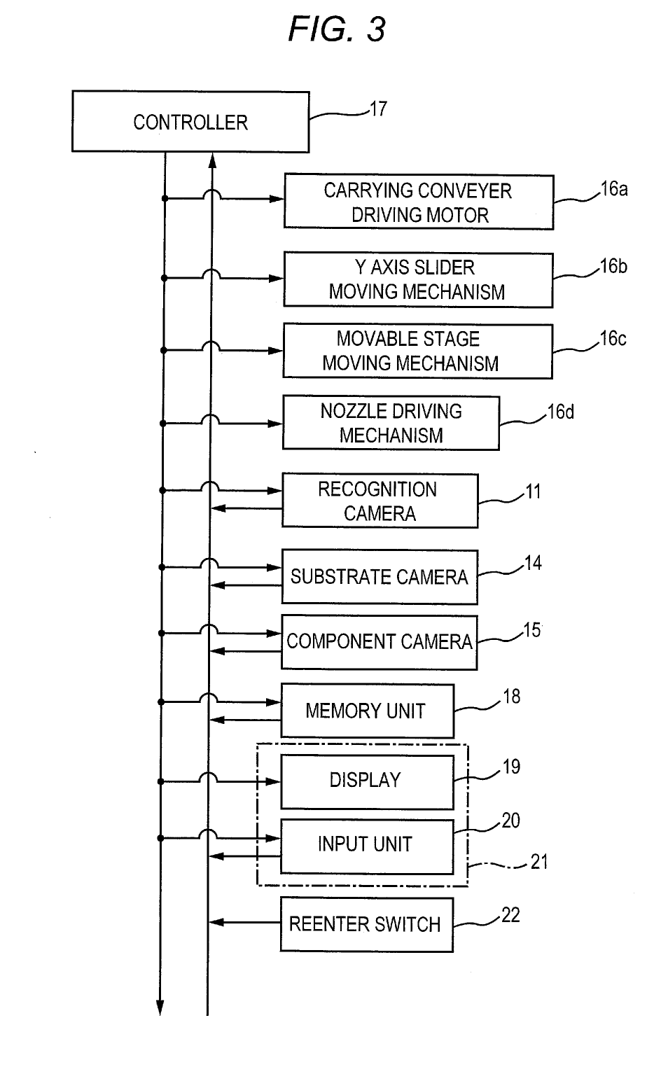

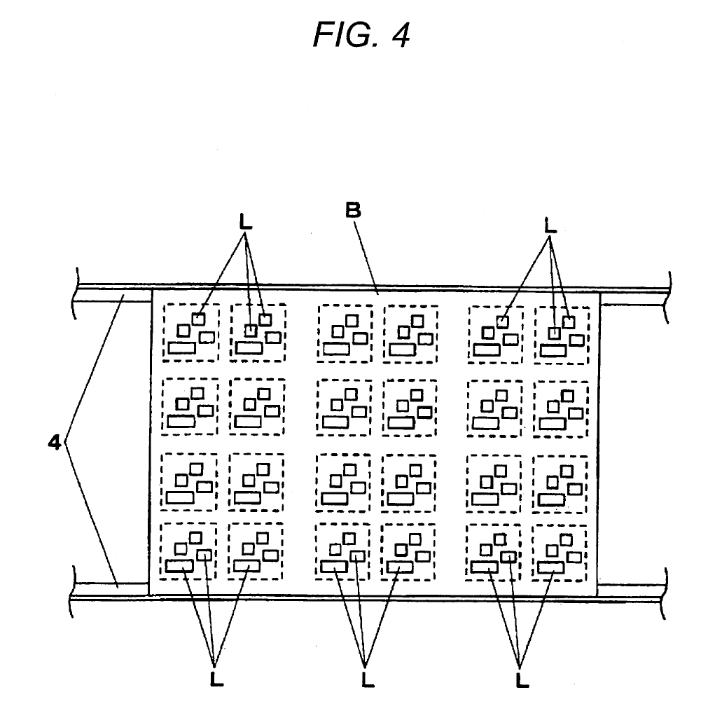

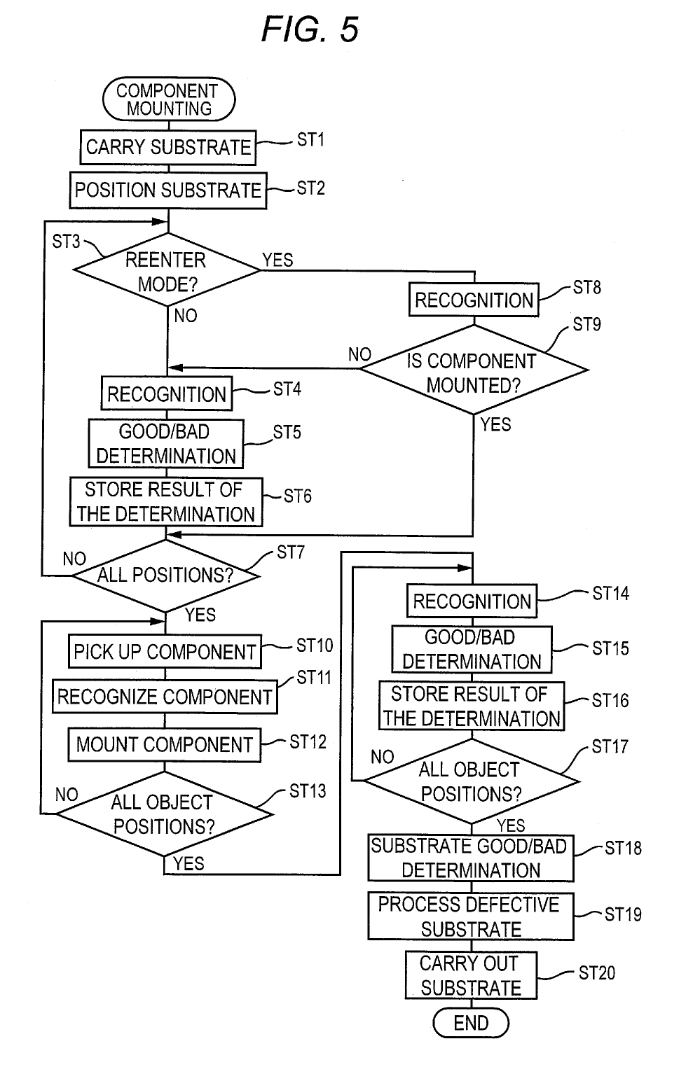

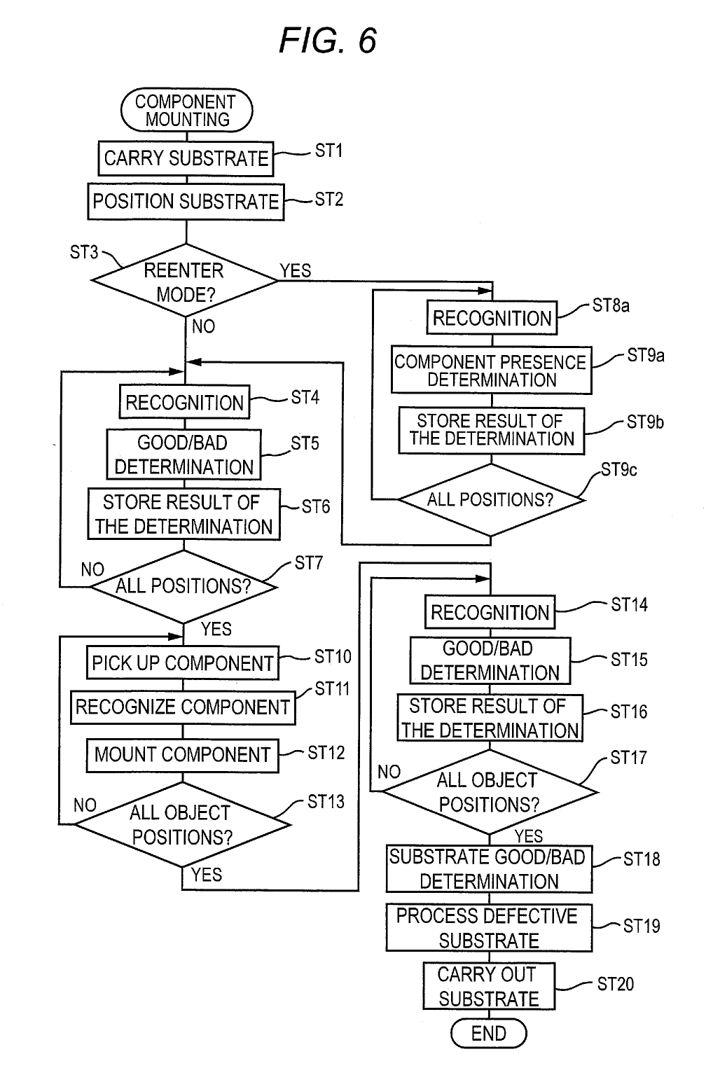

Hereinafter, an embodiment of the present invention will be described with reference to the drawings. FIG. 1 is a perspective view of a component mounter attached with substrate inspection device according to an embodiment of the present invention, FIG. 2 is a plan view of the component mounter attached with substrate inspection device according to the embodiment of the present invention, FIG. 3 is a block diagram showing a control system of the component mounter attached with substrate inspection device according to the embodiment of the present invention, FIG. 4 is a plan view of an exemplary substrate on which components are mounted by the component mounter attached with substrate inspection device according to the embodiment of the present invention, and FIGS. 5 and 6 are flow charts showing a sequence of component mounting performed by the component mounter attached with substrate inspection device according to the embodiment of the present invention.

In FIGS. 1 and 2, a component mounter attached with substrate inspection device 1 functions as one apparatus (component mounting machine) constituting a mounting line including a screen printer, a component mounting unit, an inspecting device, a reflow furnace and so on.

The component mounter attached with substrate inspection device 1 (hereinafter abbreviated as “component mounter 1”) includes a carrying conveyer 4 as a substrate carrying unit for carrying and positioning a substrate B onto a base 3 inside a cover member 2 in a horizontal direction (X axis direction) and a Y axis table 5 which is disposed above the carrying conveyer 4 and extends a direction (Y axis direction) horizontally perpendicular to a carrying direction (X axis direction) of the substrate B by the carrying conveyer 4. The Y axis table 5 is movably provided with two Y axis sliders 6 along the Y axis table 5 (i.e., in the Y axis direction) and each of the Y axis sliders 6 is mounted with one end of an X axis table 7 extending in the X axis direction. Each X axis table 7 is provided with a movable stage 8 which is movable along the X axis table 7 (i.e., in the X axis direction). One of these two movable stages 8 is provided with a mounting head 10 having a plurality of absorption nozzles 9 and the other of the movable stages 8 is provided with a camera head 12 having a recognition camera 11 with its field of vision directing downward.

In FIGS. 1 and 2, a lateral region of the mounting head 10 of the carrying conveyer 4 is lined with a plurality of component supplying units (for example, tape feeders) 13, which supplies components P (FIG. 1) to the mounting head 10, in the X axis direction. The mounting head 10 is provided with a substrate camera 14 with its imaging surface directing downward and a component camera 15 with its imaging surface directing upward is placed on the base 3.

In FIG. 3, the component mounter 1 further includes a carrying conveyer driving motor 16a for driving the carrying conveyer 4, a Y axis slider moving mechanism 16b for moving the Y axis sliders 6 along the Y axis table 5, a movable stage moving mechanism 16c for moving the movable stages 8 along the X axis table 7, and a nozzle driving mechanism 16d for elevating and rotating the absorption nozzles 9 individually around the vertical axis (Z axis) and absorbing the components P to the absorption nozzles 9.

Operation of these carrying conveyer driving motor 16a, the Y axis slider moving mechanism 16b, the movable stage moving mechanism 16c and the nozzle driving mechanism 16d is controlled by a controller 17 (FIG. 3) provided in the component mounter 1 for control of carrying and positioning of the substrate B by the carrying conveyer 4, control of moving of the mounting head 10 and the camera head 12, control of elevation of the absorption nozzles 9, etc. Here, since the recognition camera 11 (and the camera head 12) can be moved independent of the mounting head 10, it is movable with respect to the substrate B positioned on the carrying conveyer 4, similarly to the mounting head 10.

Operation of the recognition camera 11, the substrate camera 14 and the component camera 15 is controlled by the controller 17, and results of imaging from the recognition camera 11, the substrate camera 14 and the component camera 15 are input to the controller 17 (FIG. 3). In addition, a memory unit 18 connected to the controller 17 stores various data including such data as kinds of the components P received in the component supplying units 13, mounting positions (component mounting positions L, see FIG. 4) of the components P on the substrate B, an order of mounting the components P on the substrate B, etc.

In FIGS. 1 and 2, the cover member 2 is provided with an operation panel 21 having a display 19 and an input unit 20, and an operator of the component mounter 1 can perform a required input operation through the input unit 20 while viewing an image displayed on the display 19.

In addition, at one end of the carrying conveyer 4 (at an upper stream of flow of the substrate B), provided is a reenter switch 22 operated by the operator when the substrate B once carried out of the component mounter 1 is again entered (see FIG. 3). When the reenter switch 22 is operated by the operator, an operation signal is input to the controller 17 (FIG. 3) and an operation state of the controller 17 is set to a reenter mode.

Next, a component mounting sequence in which the components P are mounted on the substrate B by the component mounter 1 will be described with reference to a flow chart of FIG. 5. In the following description, the component mounting sequence of the component mounter 1 is described to include an order of performance of a substrate inspection method according to an embodiment of the present invention.

In component mounting of the component mounter 1, first, the controller 17 drives the carrying conveyer 4 to carry the substrate B entered (fed) from an apparatus at an upper steam into the component mounter 1 (Step ST1 in FIG. 5) and position the substrate B at a predetermined position (Step ST2). In Step ST2, the controller 17 moves the mounting head 10 above the substrate B and causes the substrate camera 14 provided in the mounting head 10 to recognize (image) a positioning mark (not shown) of the substrate B in order to obtain any position deviation from a reference position of the substrate B.

After completion of Step ST2, the controller 17 performs an inspection process before component mounting (Step ST3 to Step ST9). In the inspection process before component mounting (Step ST3 to Step ST9), the controller 17 first makes a determination on whether or not a reenter mode is currently set (Step ST3). If it is determined in Step ST3 that the reenter mode is not currently set, the controller 17 proceeds to Step ST4 where the inspection process before component mounting (Step ST4 to Step ST6) is performed. In this inspection process before component mounting (Step ST4 to Step ST6), the controller 17 moves the camera head 12 (that is, the recognition camera 11) above the component mounting position L on the substrate B, recognizes the component mounting position L (Step ST4), determines whether or not the components P can be mounted on the component mounting position L (good/bad determination) (Step ST5), and stores a result of the determination in the memory unit 18 (Step ST6). Next, in a determination step (Step ST7) after the inspection process before component mounting (Step ST4 to Step ST6), it is determined whether or not an inspection of all component mounting positions L to be inspected is completed. As a result of the determination, if it is determined that the inspection of all component mounting positions L to be inspected is not completed, the controller 17 returns to Step ST3 where component mounting positions L which have not yet inspected is inspected. Otherwise, if it is determined that the inspection of all component mounting positions L to be inspected is completed, the inspection process before component mounting is ended.

The controller 17 performs the recognition operation in Step ST4 with a field vision of the recognition camera 11 set as a field of vision suitable for determining good/bad of the component mounting positions L (a field of vision on the assumption that the components P are not mounted on the component mounting positions L). In addition, in the good/bad determination of Step ST5, specifically, a determination is made whether or not a component mounting position L on the substrate B is damaged, or if a component P to be mounted is a shield component, a determination is made whether or not a component covered by the shield component (the component covered by the shield component being mounted on the substrate B by another component mounter disposed at the upper stream of this component mounter 1) is normally mounted on a predetermined position on the substrate B.

On the other hand, if it is determined in Step ST3 that the reenter mode is currently set, the controller 17 proceeds to a component presence inspection process (Step ST8 and Step ST9). However, this component presence inspection process (Step ST8 and Step ST9) is performed only when the substrate B is again entered (which will be described later).

When the inspection process before component mounting (Step ST3 to Step ST9) is ended, the controller 17 performs a next component mounting process (Step ST10 to Step ST13). The component mounting process (Step ST10 to Step ST13) is a process of mounting the components P on all component mounting positions L determined to be good in the good/bad determination step (Step ST5) of the just previous inspection process before component mounting (Step ST3 to Step ST9).

In this component mounting process (Step ST10 to Step ST13), the controller 17 continues to perform a series of component mounting processes (Step ST 10 to Step ST12) of moving the mounting head 10 to pick up (absorb) the components P to be supplied to a component supplying port 13a (FIG. 2) of the component supplying unit 13 on the absorption nozzle 9 of the mounting head 10 (Step ST10), moving the mounting head 10 right above the component camera 15 to cause the component camera 15 to recognize (image) the component P in order to obtain position deviation of the component P with respect to the absorption nozzle 9 (Step ST11), and mounting the component P on the component mounting position L (Step ST12), until it is detected in a determination step (Step ST13) after Step ST12 that the component mounting process (Step ST10 to Step ST12) for all component mounting positions L (determined to be good in the good/bad determination step of the inspection process before component mounting) on which the components are mounted is ended.

According to this component mounting process (Step ST10 to Step ST13), the components P are mounted on all the component mounting positions L determined to be good in the good/bad determination step (Step ST5) of the inspection process before component mounting (Step ST3 to Step ST9), which means that the inspection process before component mounting (Step ST3 to Step ST9) for component mounting positions L (defective positions) determined to be bad in Step ST5 of the inspection process before component mounting (Step ST3 to Step ST9) is skipped and the component P is not mounted on the bad component mounting positions L.

In the component mounting process (Step ST10 to Step ST12), the controller 17 corrects position deviation from the reference position of the substrate B obtained in Step ST2 and position deviation of the components P with respect to the absorption nozzles 9 obtained in Step ST11.

When the component mounting process (Step ST10 to Step ST13) is ended, a subsequent inspection process after component mounting (Step ST14 to Step ST17) is performed. The inspection process after component mounting (Step ST14 to Step ST17) is a process of recognizing all the component mounting positions L on which the components P are mounted in the above-described component mounting process (Step ST10 to Step ST13) (that is, the component mounting positions L of the substrate B after component mounting) as an inspection object by the recognition camera 11 and then inspecting whether or not the components P are correctly mounted on the component mounting positions L.

In this inspection process after component mounting (Step ST14 to Step ST17), the controller 17 continues to perform a series of inspection processes after component mounting (Step ST14 to Step ST16) of moving the camera head 12 (that is, the recognition camera 11) above the component mounting positions L on the substrate B on which the components are mounted in the component mounting process (Step ST10 to Step ST13) to recognize the component mounting positions L (Step ST14), determining whether or not the components P are correctly mounted on the component mounting positions L (good/bad determination) (Step ST15), and storing a result of the determination in the memory unit 18 (Step ST16), until it is detected in a determination step (Step ST17) after Step ST16 that the inspection processes after component mounting (Step ST14 to Step ST16) for all the component mounting positions L to be inspected are ended.

For the recognition in Step ST14, the controller 17 may set a field of vision of the recognition camera 11 to a field of vision suitable for inspection of the presence of the components P (a field of vision on the assumption that the components P are mounted on the component mounting positions L, which is typically wider than a field of vision on the assumption that the components P are not mounted on the component mounting positions L).

When the inspection processes after component mounting (Step ST14 to Step ST17) is ended, the controller 17 proceeds to the next Step ST18.

In Step ST18, the controller 17 performs a good/bad determination on the substrate B on the carrying conveyer 4. Here, a substrate B recognized to have a defective position in the inspection processes before component mounting (Step ST3 to Step ST9) (accordingly on which the components P are not mounted in the component mounting process) and substrate B recognized to have a defective position in the inspection processes after component mounting (Step ST14 to Step ST17) are determined to be a defective substrate, and a substrate B recognized to have no defective position in any of the inspection processes before component mounting (Step ST3 to Step ST9) and the inspection processes after component mounting (Step ST14 to Step ST17) is determined to be a good substrate. In addition, the performance of the process of Step ST14 to Step ST17 may be optional, not essential. In addition, these steps may be performed only for particular components P.

When Step ST18 is ended, the controller 17 performs a process required for a substrate B determined to be a defective substrate (defective substrate process) (Step ST19). The defective substrate process in Step ST19 includes a process of putting a mark on the defective substrate so that an operator can check a defective position on the defective substrate by visual inspection.

When Step ST19 is ended, the controller 17 controls the carrying conveyer 4 to discharge the substrate B to an apparatus at a lower stream of the component mounter 1 (as indicated by an arrow A in FIGS. 1 and 2, Step ST20). Thereby, a series of component mounting process by the component mounter 1 is ended.

Here, after the substrate B is carried out of the component mounter 1 in Step ST20, when the operator who recognized the substrate B as a defective substrate and the defective position from a mark formed on the substrate B repairs the defective position of the substrate B, the operator can again enter the substrate B in the component mounter 1. The reentrance of the substrate B is carried out by entering the substrate B in an upper stream of the carrying conveyer 4 by the operator. When the operator enters the substrate B again, the operator operates the reenter switch 22 to set an operation state of the controller 17 to a reenter mode.

When the substrate B is entered in the carrying conveyer 4, although the controller 17 performs the above-described component mounting process, starting from Step ST1, since it determines that the reenter mode is currently set in Step ST3 of the inspection process before component mounting (Step ST3 to Step ST9), the controller 17 proceeds to the component presence inspection process (Step ST8 and Step ST9).

In the component presence inspection process (Step ST8 and Step ST9), the controller 17 moves the camera head 12 (that is, the recognition camera 11) above the component mounting position L on the substrate B to recognize the component mounting position L (Step ST8), and then determines whether or not the component P has been already mounted on the component mounting position L (component presence determination) (Step ST9).

For the recognition in Step ST8, the controller 17 may set a field of vision of the recognition camera 11 to a field of vision suitable for inspection of the presence of the component P (a field of vision on the assumption that the component P is mounted on the component mounting position L).

The controller 17 stores the component mounting position L, as the inspection object, which is determined in Step ST9 that the component P is not mounted thereon, in the memory unit 18, performs the above-described inspection process before component mounting (Step ST4 to Step ST6) for the component mounting positions L stored as the inspection object, and then proceeds to Step ST7. On the other hand, the controller 17 stores the component mounting position L, as a non-inspection object, which is determined in Step ST9 that the component P is mounted thereon, in the memory unit 18, skips the inspection process before component mounting (Step ST4 to Step ST6) for the component mounting positions L stored as the non-inspection object, and then proceeds to Step ST7.

In Step ST7, since the controller returns to Step ST3 until the inspection of all the component mounting positions L as inspection objects is ended, the controller performs the inspection process before component mounting (Step ST3 to Step ST9) for all the component mounting positions L of the substrate B entered again and performs the inspection process before component mounting (Step ST4 to Step ST6) for the component mounting positions L on which the components P are not mounted.

In this manner, when the reenter mode is set, the component mounter 1 according to this embodiment first causes the recognition camera 11 to recognize the component mounting position L, performs the component presence inspection process (Step ST8 and Step ST9) to determine whether or not the component P is mounted on the component mounting position L, and then performs the inspection process before component mounting (Step ST4 to Step ST6) for the component mounting position L on which the component P is not mounted.

When the inspection process before component mounting (Step ST3 to Step ST9) for all the component mounting position L of the substrate B entered again is ended, the controller 17 performs the above-described component mounting process (Step ST10 to Step ST13) for the component mounting position L determined to be good in the good/bad determination step (Step ST5) of the inspection process before component mounting (Step ST3 to Step ST9).

When the component mounting process (Step ST10 to Step ST13) is ended, the controller 17 performs the inspection process after component mounting (Step ST14 to Step ST17). Here, the controller performs the inspection process after component mounting (Step ST14 to Step ST16) for all the component mounting position L having components mounted thereon in the just previous component mounting process (Step ST10 to Step ST13) (the component mounting positions L stored as the inspection object in the memory unit 18 in Step ST9). In addition, here, the performance of the process of Step ST14 to Step ST17 may be optional.

When the inspection process after component mounting (Step ST14 to Step ST17) is ended, a good/bad determination (Step ST18) on the substrate B entered again and a process (Step ST19) required for the substrate B determined to be bad are performed and the substrate B is discharged (Step ST20). When the substrate B is discharged, the controller 17 releases the set reenter mode.

As can be known from the above description, the component mounter (component mounter attached with substrate inspection device) 1 according to this embodiment includes the recognition camera 11 which is movable with respect to the substrate B positioned by the carrying conveyer 4, the controller 17 as an inspection execution unit for causing the recognition camera 11 to recognize the component mounting position L on the substrate B and performing an inspection before component mounting (the inspection process before component mounting of Step ST4 to Step ST6) which inspects whether or not the component P can be mounted on the component mounting position L, and the reenter switch 22 as a reenter mode setting unit for setting the controller 17 to a reenter mode to constitute the substrate inspection device according to an embodiment of the present invention. The controller 17 performs the inspection before component mounting (the inspection process before component mounting of Step ST4 to Step ST6) for all the component mounting positions L on which components are to be mounted when the reenter mode is not set by operation of the reenter switch 22, and first causes the recognition camera to recognize the component mounting position L and then performs a component presence inspection (the component presence inspection process of Step ST8 and Step ST9) which inspects whether or not the component P is mounted on the component mounting position L when the reenter mode is set by operation of the reenter switch 22. As a result, the inspection before component mounting (the inspection process before component mounting of Step ST4 to Step ST6) for the component mounting position L on which the component P is not mounted is performed.

In addition, the substrate inspection method according to this embodiment is to cause the recognition camera 11, which is movable with respect to the positioned substrate B, to recognize the component mounting position L on the substrate B, and then to perform an inspection before component mounting which inspects whether or not the component P can be mounted on the component mounting position L. If the reenter mode is not set by operation of the reenter switch 22, the inspection before component mounting (the inspection process before component mounting of Step ST4 to Step ST6) for all the component mounting positions L on which components are to be mounted is first performed, and if the reenter mode is set by operation of the reenter switch 22, the recognition camera 11 is caused to recognize the component mounting position L and then a component presence inspection (the component presence inspection process of Step ST8 and Step ST9) which inspects whether or not the component P is mounted on the component mounting position L is performed. As a result, the inspection before component mounting (the inspection process before component mounting of Step ST4 to Step ST6) for the component mounting position L on which the component P is not mounted is performed.

In this manner, in the substrate inspection device (substrate inspection method) according to this embodiment, in normal substrate entrance where the reenter mode is not set, the inspection before component mounting (the inspection process before component mounting of Step ST4 to Step ST6) for all the component mounting positions L on which components are to be mounted is performed, and, in reentrance of the substrate 8 where the reenter mode is set, the recognition camera 11 is first caused to recognize the component mounting position L and then the component presence inspection (the component presence inspection process of Step ST8 and Step ST9) which inspects whether or not the component P is mounted on the component mounting position L is performed. As a result, the inspection before component mounting (the inspection process before component mounting of Step ST4 to Step ST6) for the component mounting position L on which the component P is not mounted is performed. Accordingly, it is possible to efficiently perform the inspection before component mounting without performing an unnecessary inspection before component mounting for a component mounting position L on which the component P has been already mounted.

In addition, since the component presence inspection (the component presence inspection process of Step ST8 and Step ST9) in reentrance of the substrate B is performed in a field of vision of the recognition camera 11 suitable for inspection of the presence of the component P (a field of vision on the assumption that the component P is mounted on the component mounting position L), if the component P is not mounted on the component mounting position, the component mounting position L is recognized (thereafter, when the field of vision is switched to a field of vision suitable for determining good/bad of the component mounting position L, a good/bad determination on the component mounting position L can be performed). On the other hand, if the component P is mounted on the component mounting position L, since the component P is recognized, there is no abnormality to be determined and accordingly there occurs no system error.

Although the embodiment of the present invention has been described in the above, the present invention is not limited to the above-described embodiment. For example, although it has been configured in the above embodiment that a loop for performing the component presence inspection process (Step ST8 and Step ST9) for all the components P uses a loop of the inspection process before component mounting (Step ST3 to Step ST9), without being limited to such a configuration, as shown in a flow chart of FIG. 6, it may be configured that a component presence inspection process (Step ST8a to Step ST9c) continuing a series of processes of recognizing the component mounting position L (Step ST8a), performing a determination on whether or not the component P has been already mounted on the component mounting position L (component presence determination) (Step ST9a), and storing a result of the determination in the memory unit 18 (Step ST9b) is performed, until it is detected in a determination step (Step ST9c) after Step ST9b that the above process (Step ST8a to Step ST9b) for all the component mounting positions L on the substrate B is ended. In this case, in the next inspection process before component mounting (Step ST3 to Step ST9), the inspection process before component mounting (Step ST4 to Step ST6) may be performed for only the component mounting position L as an inspection object, which is determined in the component presence inspection process (Step ST8a to Step ST9c) that the component P is not mounted thereon. In addition, in the flow chart of FIG. 6, the steps denoted by the same reference numerals as the flow chart of FIG. 5 have the same contents as the flow chart of FIG. 5.

In addition, although it has been configured in the above embodiment that the recognition camera 11 is mounted on the camera head 12 provided in the component mounter 1 such that the camera head is movable independent of the mounting head 10 and the substrate inspection device is integrally formed (as a portion of the component mounter 1) with the component mounter 1, the substrate inspection device may not be necessarily integrally formed with the component mounter 1, but may be separately provided at an upper stream of the component mounter 1. However, as in the above embodiment, when the substrate inspection device is integrally formed with the component mounter 1, since the number of apparatuses in a component mounting line can be reduced, costs can be significantly reduced. In addition, since the component P can be mounted as it is without moving the substrate B after performing the inspection before component mounting (Step ST4 to Step ST6), it is advantageous in that components can be mounted with high precision. In addition, as described above, since the inspection process after component mounting (Step ST14 to Step ST17) can be also performed, the number of apparatuses in the component mounting line can be further reduced as much.

A substrate inspection device and a substrate inspection method are provided which are capable of performing an inspection before component mounting with high efficiency when a substrate is again entered, thereby preventing system errors from occurring.

1. A substrate inspection device comprising:
a recognition camera that is movable with respect to a positioned substrate;
an inspection execution unit that causes the recognition camera to recognize a component mounting position on the substrate and performs an inspection process before component mounting which inspects whether or not a component can be mounted on the component mounting position; and
a reenter mode setting unit that sets the inspection execution unit to a reenter mode,
wherein the inspection execution unit performs the inspection process before component mounting for all component mounting positions on which components are to be mounted when the reenter mode is not set by operation of the reenter mode setting unit, first causes the recognition camera to recognize the component mounting position and then performs a component presence inspection process which inspects whether or not the component is mounted on the component mounting position when the reenter mode is set by operation of the reenter mode setting unit, and, performs the inspection process before component mounting for the component mounting position on which the component is not mounted.

2. The substrate inspection device according to claim 1,
wherein the apparatus is provide in a component mounter that moves a mounting head with respect to the positioned substrate and mounts the component on the component mounting position on the substrate, and the recognition camera is mounted on a camera head that is movably provided independent of the mounting head.

3. A substrate inspection method for causing a recognition camera, which is movably provided with respect to a positioned substrate, to recognize a component mounting position on the substrate, and performing an inspection process before component mounting which inspects whether or not a component can be mounted on the component mounting position,
wherein the inspection before component mounting for all component mounting positions on which components are to be mounted is performed when a reenter mode is not set by a reenter mode setting unit, the recognition camera is first caused to recognize the component mounting position and then a component presence inspection process which inspects whether or not the component is mounted on the component mounting position is performed when the reenter mode is set, and, the inspection process before component mounting is performed for the component mounting position on which the component is not mounted.
